(19) United States
(12) Patent Application Publication
(10) Pub. No.: US 2022/0318912 A1
(43) Pub. Date: Oct. 6, 2022

(54) SYSTEMS AND METHODS FOR MEASURING PRE-VOTE OUTCOMES

(71) Applicant: Richard BRAND, New York, NY (US)

(72) Inventor: Richard BRAND, New York, NY (US)

(21) Appl. No.: 17/626,332

(22) PCT Filed: Jul. 7, 2020
(86) PCT No.: PCT/US20/40996

§ 371 Date: Jan. 11, 2022

Related U.S. Application Data
(60) Provisional application No. 62/873,474, filed on Jul. 12, 2019.

(51) Int. Cl. G06Q 40/06

(52) U.S. Cl. CPC G06Q 40/06; G06Q 2230/00

(57) ABSTRACT

Computer-implemented systems and methods for improving the quality of shareholder voting by generating a pre-vote outcome of a corporate vote. The method comprises receiving, by a computer, pre-votes from a plurality of shareholders for a proposition to be voted on during the corporate vote; adjusting each shareholder's pre-vote by a reliability factor and anonymizing the pre-votes; and generating the pre-vote outcome.

This application claims the priority benefit of U.S. provisional patent application No. 62/873,474, filed on Jul. 12, 2019, the contents of which are incorporated herein by reference in their entirety.

### FIELD OF THE INVENTION

The present invention is directed to providing improvements in the predictability and quality of shareholder voting. Specifically, the present invention is directed to computer-implemented methods and systems for generating a pre-vote outcome for a corporate vote by executing at least one of anonymizing and adjusting the pre-votes, and providing the pre-vote outcome to shareholders to assist other shareholders to cast their vote during a corporate vote.

### BACKGROUND

Shareholder voting rights are central to corporate governance, enabling shareholders to provide their viewpoint and voice to protect their economic interests. Some propositions at corporate votes may be considered mundane, such as advisory votes on compensation plans or annual reelection of incumbent directors. Other propositions at corporate votes may be more contentious, such as contested director elections and mergers and acquisitions. All corporate votes, whether mundane or contentious, are potentially important in that they guide the company in its future business.

Despite rhetoric about shareholder democracy, share ownership is currently dominated by institutions and not by individuals, as institutions hold about 70% of outstanding corporate stock while individuals hold only about 30%. Institutions have higher voting participation rates, voting about 91% of shares, while individuals typically vote only about 29% of shares held.

Among institutions, ownership is dominated by indexers who offer investment products such as stock index funds which are portfolios that closely match a market index such as the Russell 2000 or S&P 500. The indexer's portfolio of stocks is the same as the index it tracks, where the indexer may own stock in multiple companies who compete in the same market space, demographic or technology. Such a portfolio is consider an “unweighted” portfolio because its success is independent of the success or failure of a particular company in that space. In contrast, certain active investors own shares of individual industry participants and are therefore considered “weighted” investors. Weighted portfolios are more dependent on the success of their individual investments and therefore have significant interest in the issues that come up for voting. Only a minority of indexers research the businesses they invest in and cast their shareholder votes as a result of this research, primarily in order to minimize costs. Therefore such investors are often considered as passive investors in their holdings. Such passive indexers rely in large part on preset general internal voting guidelines or recommendations of outside advisors such as proxy advisors in their voting decisions. The two largest proxy advisors, Institutional Shareholder Services (ISS) and Glass Lewis, together control about 97% of the proxy advisory market.

Since 2003, the Securities and Exchange Commission has permitted institutional investors to meet their fiduciary duty to adopt and disclose proxy voting guidelines by relying on proxy advisors. Certain advisors, for example, ISS and Glass Lewis, include customers' social and environmental factors in their voting preferences. Independent empirical research shows that for extraordinary matters such as proxy contests and takeovers, proxy advisor recommendations tend to increase shareholder returns. On more routine matters such as compensation plans and director elections, proxy advisor recommendations tend to reduce shareholder returns. It is generally agreed that advisors in general will provide better advice when they deploy resources to research particular questions, rather than relying on preset general voting guidelines.

Bills in Congress have been introduced to adapt rules for proxy advisors along the lines of those governing credit rating agencies, such as transparency and disclosure of conflicts. Other ideas for improving proxy advisor oversight include imposing fiduciary duties on advisors or mandated testing and disclosure of the value of their recommendations. Another proposal would move to pro rata voting for indexers, so that indexers could cast their votes in proportion to the votes of all other shareholders. Such a proposal would require SEC approval and therefore this approval may prove difficult to obtain.

There is therefore an unmet need for a method and system of providing corporate voting recommendations to investors who may not conduct their own research and therefore may not vote in accordance with the issuer's best economic interests. There is also a need for methods and systems to encourage investors who may not conduct their own corporate research, such as indexers and/or passive investors, to consider pre-voting data calculated from active investors. With the expected vote information from active investors whose portfolio is weighted, the indexers and/or passive investors may be motivated to vote in accordance with the gathered voting information, to promote more well-informed corporate governance. There is also an unmet need to provide indexers and/or other passive shareholders with voting selections of active shareholders, such as active institutional investors who conduct research. Such needed methods and systems should be (1) low-cost as indexers seek to minimize costs spent on research, and (2) electronic so as to rapidly furnish such information to interested parties. There is also an unmet need for methods and systems which can be used to at least partly offset the role or influence of proxy advisors in order to improve the quality of shareholder voting.

### SUMMARY OF THE INVENTION

The present invention relates to a cost-effective solution to the needs mentioned above by providing a computer-implemented method and system for generating a pre-vote outcome. The method comprises the steps of receiving, by the computer, pre-votes from a plurality of shareholders for a proposition; adjusting each shareholder's pre-vote by a reliability factor to obtain an adjusted pre-vote for each shareholder, wherein the reliability factor comprises a correlation of a shareholder's pre-vote relative to the shareholder's historical vote; anonymizing the pre-votes; generating the pre-vote outcome for the proposition based on the adjusted and anonymized pre-votes; and displaying, by the computer in electronic form, information about the pre-vote outcome.

Use of the present invention will typically be offered to shareholders shortly before a corporate vote after the propositions to be voted on have been announced by the issuer of a security. The corporate vote can be any kind of corporate meeting (real, virtual, or online) at which shareholders are entitled to vote on a proposition. The corporate vote can be a general meeting which periodically recurs, such as a quarterly or annual meeting, or the corporate vote can be a specially-scheduled vote, such as an extraordinary meeting, for example, to approve a merger or acquisition.

The pre-vote outcome can be generated for all pre-voting shareholders, or separate pre-vote outcomes can be generated for different classes of shareholders, such as active shareholders and passive shareholders. In this manner, interested parties can identify voting differences between the classes and potentially make voting or investment decisions based on the pre-voting outcomes. For example, if pre-votes from active and passive shareholders are separately cast and pre-vote outcomes are separately generated, passive shareholders can view the voting behavior of the active shareholders and thereby be motivated to vote in the subsequent corporate vote in the same manner as the active shareholders.

If the number or percentage of pre-voting shareholders is below the pre-designated threshold, the system and method of the invention may provide an alternative vote summary instead of a calculated pre-vote outcome. The alternative vote summary may be a descriptive analysis of the pre-voting results and may optionally explain that there are insufficient data to generate the pre-vote outcome. Once the threshold percentage or number of votes or pre-voting shareholders has been reached, the method and system of the invention updates and revises the pre-vote outcome.

The method and system of the invention can be used to generate pre-voting outcomes for any number of propositions at a corporate vote. For example, the method can generate a pre-vote outcome for a single proposition, or a plurality of propositions. If there are a plurality of propositions, the method generates a pre-vote outcome for each of the plurality of propositions.

Another aspect of the present invention is directed to a system for generating a pre-vote outcome for a corporate vote. The system comprises a database configured to store bibliographic voter information and pre-votes for a plurality of shareholders, and a value corresponding to the generated pre-vote outcome; and a remote device connected to a server over an electronic network and configured for requesting access to the database.

The server of the present invention comprises a memory, a processor, and computer program instructions which, when executed by a computer, cause the server to execute a method of generating a pre-vote outcome comprising the steps of receiving, by the computer, pre-votes from a plurality of shareholders for a proposition; adjusting each shareholder's pre-vote by a reliability factor to obtain an adjusted pre-vote for each shareholder, wherein the reliability factor comprises a correlation of a shareholder's pre-vote relative to the shareholder's historical vote; anonymizing the pre-votes; generating the pre-vote outcome for the proposition based on the adjusted and anonymized pre-votes; and displaying, by the computer in electronic form, information about the pre-vote outcome. In certain embodiments, the system according to this aspect of the invention can be implemented as a data processing system comprising a processor configured to perform the method of the invention.

Another aspect of the present invention is directed to a computer program product comprising a non-transitory computer-readable medium containing a program which, when executed by a computer, causes the computer to execute a method of generating an pre-vote outcome comprising the steps of receiving, by the computer, pre-votes from a plurality of shareholders for a proposition; adjusting each shareholder's pre-vote by a reliability factor to obtain an adjusted pre-vote for each shareholder, wherein the reliability factor comprises a correlation of a shareholder's pre-vote relative to the shareholder's historical vote; anonymizing the pre-votes; generating the pre-vote outcome for the proposition based on the adjusted and anonymized pre-votes; and displaying, by the computer in electronic form, information about the pre-vote outcome.

### BRIEF DESCRIPTION OF THE DRAWINGS

The foregoing and other objects and advantages will be apparent upon consideration of the following detailed description, taken in conjunction with the accompanying drawings, in which like reference characters refer to like parts throughout, and in which:

FIG. 1 shows a flow chart illustrating steps of the inventive method; and

FIG. 2 shows an embodiment of a computer system for providing access to a pre-vote outcome comprising an electronic database and a server.

### DETAILED DESCRIPTION OF THE INVENTION

The present invention uses pre-votes to generate the anticipated outcome of a corporate vote. The term “pre-vote” (whether singular or plural) or “pre-voting” refers to votes cast for a proposition by shareholders using the present method or system in advance of a corporate vote for the same proposition. The term “proposition” refers to any kind of ballot measure, proposal, or question that is placed before shareholders at a corporate vote. Examples of propositions are an election of a director or officer, a corporate resolution, and a shareholder resolution. Elections of directors or officers of a company, such as but not limited to CEO or president, are highly well known in the art, and therefore do not need to be further described. Corporate resolutions are any kind of propositions which originated from the issuer, such as approval of auditors or appointment of directors, whereas shareholder resolutions are those propositions submitted by shareholders, such as advisory votes on executive compensation.

Although the system and method of the present invention may be described with reference to propositions having two choices, e.g. Yes/No or For/Against, there may be additional choices for a given proposition, such as Yes/No/Abstain or only a single choice such as Yes or No, depending on how the proposition is written and in accordance with corporate bylaws and relevant regulations.

Unless further qualified, the term “shareholder” (whether singular or plural) refers to a holder of a financial security issued by an issuer and which provides voting rights to the holder. For example, a shareholder can be an owner of common stock of an issuer. As securities can be owned by institutions or individual investors, shareholders can therefore be corporate holders of the subject security or individuals. The term “shareholder” as used herein also encompasses beneficial owners of a subject security, as is known in the art. Shareholders can also be trustees, custodians, agents, or proxies who hold or manage the financial securities for another party and can vote in a corporate vote. The term “issuer” refers to the issuing entity which has issued the financial security for investment by shareholders. A “security” or “financial security” (whether singular or plural) is any kind of tradeable financial asset or financial instrument, and it can be in certificated or non-certificated (electronic) form. For ease of discussion, the security may be referred to as a share but it is to be understood that the invention is not limited to shares and encompasses other types of securities which offer voting rights. “Active investors” are those who have a hands-on approach to their investments and continuously monitor their portfolio to exploit profitable conditions. “Passive investors” are those who limit the amount of buying and selling of securities within their portfolios and have a buy-and-hold investment strategy.

In an embodiment of the present invention, the shareholders are holders of an equity security issued by the issuer, such as common stock or preferred stock of a corporation, which provides voting rights to the shareholders. In other embodiments, the shareholders are holders of a debt security or a hybrid security (such as equity warrants or convertible bonds) which provides voting rights to the holders of that security.

The reliability factor adjusts pre-votes to account for shareholders' stated intentions of how they will vote (their pre-vote) in relation to how the shareholders actually voted (their actual vote) in the past. The actual vote may be identified by surveys or in conjunction with public electronic voting databases such as the “Voting Analytics” database offered by Institutional Shareholder Services, Inc. or based on stored voting records in the system of the present invention.

The reliability factor can have any scale, such as 0 to 10, 0 to 100, etc. and may comprise factors other than (or in addition to) historical voting. For example, the shareholder reliability factor may comprise one or more of the number of securities owned, type of securities owned, shareholder diversification, and shareholder leverage, as are known in the art. Other characteristics or considerations may be used as deemed appropriate to arrive at shareholders' reliability factors. The reliability factor is expected to be recalculated over time to reflect the shareholder's most recent or most comprehensive voting behavior. The reliability factor may vary for a given shareholder over its holdings or based on the subject issuer.

As the reliability factor depends at least in part on input from the shareholder, it could be subject to pre-vote manipulation via inaccurate information provided by the shareholder, e.g., inflating the number of owned shares. To minimize the chances for pre-vote manipulation, the present invention may ask shareholders one or more verification questions as a data check. If the response given by the shareholder matches the expected response, the shareholder's reliability factor can be maintained or increased. If the response to the verification question provided by the shareholder does not match the expected response, and the reason for the discrepancy is not adequately explained or is omitted, the shareholder's reliability factor can be decreased to account for the inadequate response.

For example, as a verification question the invention may ask each shareholder to provide the number of shares it owns or plans to pre-vote. The number of shares input by the shareholder can be compared against publicly-available sources that provide the number of shares owned by entities such as SEC filings including 10K, 10Q, Schedule 13D Beneficial Ownership Reports, 13F filings, and proxy statements. Any discrepancies between the number of shares declared by the shareholder and the number of shares reported in the publicly-available sources should be explained by the shareholder. If the shareholder states that the discrepancy in the number of shares is because of a recent sale or purchase of shares, the response may be accepted. If the shareholder does not sufficiently explain why the number of self-reported shares is different from the publicly-available value, the shareholder's reliability factor can be adjusted downward to reflect the inadequate response.

Anonymization of the shareholder pre-votes is performed to protect shareholders' privacy and removes personally-identifiable information from the pre-votes so that each shareholder's pre-vote is anonymous. Data anonymization tools and techniques are well known in the art and commercially-available anonymization software is available from several vendors. Nevertheless, votes may not always be confidential or anonymous as industry regulations or practices may require disclosure of votes cast for a corporate vote. For example, mutual funds are required by SEC regulations to publicly disclose their proxy voting records annually. Similarly, the method and system of the present invention may, in certain circumstances, not be compiled or analyzed in an anonymized fashion.

Subscribers to the data obtained from the present invention may be interested parties who wish to access the pre-vote outcome and any additional information made available concerning the pre-vote. Subscribers will typically be registered users who have login credentials to prevent unauthorized access to the system, and non-subscribers are therefore not permitted to access to the data generated by the invention or the invention itself in the first place.

The results of the pre-vote outcome can be provided to interested parties in a number of ways. For example, subscribers can be provided with the pre-vote outcome (or access to the pre-vote outcome) upon payment of a fee, or the results can be posted online for public viewing. Subscribers can also be provided with the pre-vote outcome upon payment of a fee prior to dissemination of the pre-vote outcome to non-subscribers. Subscribers or other interested parties can thereby make investment decisions based on the pre-vote outcome, potentially with arbitrage. If the pre-vote outcome is updated on a rolling basis, subscribers may have access to the pre-vote outcome information a period of time before non-subscribers, such as 15 minutes ahead of non-subscribers. Analogously, if the pre-vote outcome is updated hourly or daily, subscribers can be granted access to the pre-vote outcome information a period of time before non-subscribers, such as 15 minutes ahead of non-subscribers.

For the generated pre-vote outcome to be representative of voting shareholders, the present invention may be configured to require receipt of a threshold number of pre-votes in order to generate the pre-vote outcome, such as a minimum number or percentage of shareholders of an issuer or a minimum number of shareholders of the issuer. In one illustrative and non-limiting example, if a security is owned by 100 shareholders, and the total number of possible pre-votes is 1,000,000 (one million), the present invention may require that at least 30% of the shareholders (that is, thirty shareholders) cast pre-votes in order to generate the pre-vote outcome. Alternatively, the system may require at least 30% (300,000) of the pre-votes must be cast before the system will generate the pre-vote outcome. Other types of thresholds as well as multilevel thresholds are within the scope of the present invention.

The present invention may also provide an outcome probability for the likelihood of passage of a proposition based on the received pre-votes and shareholder reliability factor information. The shareholder reliability factor information correlates a particular shareholder's pre-vote relative to another particular attribute of the shareholder, e.g., the shareholder's historical vote, that is, the shareholder's actual vote in prior corporate votes. For example, if the shareholder's pre-vote and actual vote in prior corporate votes have a high correlation, e.g. 100%, then the shareholder's pre-vote in a current corporate vote can be considered as having high outcome probability of being the shareholder's actual vote. If the shareholder reliability factor is lower, e.g. 50%, then the shareholder's pre-vote varies significantly from the shareholder's actual vote and the outcome probability may be, e.g. 50%. The outcome probability can be generated for any grouping of shareholders, for example, for all shareholders, for each individual shareholder, or for a predefined class of shareholders such as all active shareholders or all passive shareholders.

The present system also permits generation of voting analytics for each shareholder based on the shareholder's pre-vote and supplemental pre-voting data. For example, each shareholder's historical pre-voting data and actual voting data can be mined from prior years, and the system can model how the shareholder is expected to vote for an upcoming corporate vote. The modeling can use voting information from electronic voting databases, such as the “Voting Analytics” dataset offered by Institutional Shareholder Services, Inc. Thus, the system can predict a shareholder's pre-vote based on the shareholder's voting history or historical vote, and use the predicted pre-vote to generate the pre-vote outcome. When deemed useful, it may also be advantageous to adjust a shareholder's probability of voting in a particular way based upon the shareholder's reliability factor.

In certain embodiments, it may be useful to use a shareholder's predicted pre-vote in place of the shareholder's actual pre-vote to generate the pre-vote outcome. For example, it may be useful to pre-populate each shareholder's pre-vote with a predicted pre-vote based on the shareholder's voting history in place of an actual (or received) pre-vote, and to generate the pre-vote outcome using the predicted pre-vote. This feature of the invention advantageously allows generation of a preliminary pre-vote outcome which can serve as an initial indicator of how a corporate vote may be decided. Upon receipt of a shareholder's pre-vote, the predicted pre-vote can be replaced with the received pre-vote and the system can generate an updated pre-vote outcome with the shareholder's received pre-vote. Consequently, this feature of the invention provides the ability to predict how a corporate vote for a proposition may result before any pre-votes have been cast. The replacement of predicted pre-votes with received pre-votes provides for refinements in the pre-vote outcome as the pre-votes are received.

In certain instances, it may be desirable to exclude pre-votes cast by a class of shareholders from the pre-vote outcome. For example, pre-votes from passive shareholders may be excluded in certain circumstances in order to bias the predicted outcome on actual researched votes. Having the pre-vote outcome generated from active shareholders' pre-votes can be useful for passive shareholders to provided them the research benefits of the active shareholders.

The system and method of the present invention may be configured so that all shareholders or particular classes or categories of shareholders may cast pre-votes. However, larger issuers (e.g. larger corporations) can have several thousand (or more) shareholders and many shareholders only own a few securities or a low percentage of the total securities of an issuer. Consequently, the pre-votes (and actual votes) of smaller shareholders will usually not appreciably affect the overall vote, particularly because small shareholders typically have low voting participation rates and obtaining their pre-votes may challenging. Consequently, it may be desirable to restrict pre-voting to a category of shareholders such as large shareholders to maximize efficient use of the system.

In another embodiment, the invention may define an eligibility threshold in order for a shareholder to cast a pre-vote. For example, an eligibility threshold may be established requiring shareholders to own or manage a minimum number of securities issued by the issuer, a minimum percentage of securities issued by the issuer, or a portfolio of outstanding securities of the issuer having a minimum asset value, in order to cast a pre-vote. For example, if an issuer has 10,000 shareholders who collectively own 1,000,000 securities, an eligibility threshold may be established so that participation is limited to the largest, e.g. 100, shareholders; shareholders owning at least, e.g. 50,000, shares; or shareholders owning at least, e.g. 2%, of the outstanding securities or having a portfolio with a minimum, e.g. $100,000, asset value of the issuer, participating in the invention. The eligibility threshold can depend upon the number of issued securities and total number of eligible votes as well as any additional or alternative criteria considered relevant.

A server for use with the computer system of the present invention may comprise a processor, an input device such as a keyboard or mouse, memory such as a hard drive and volatile or nonvolatile memory, and computer code or computer programming instructions for the functioning of the invention. The computer system may be a mainframe, microcomputer, or minicomputer, or it may be a custom-designed computer. The server may be a single standalone computer system, a plurality of systems, or cloud-based as is known in the art.

The computer system of the invention may comprise a plurality of networked computers, for example, so that operations such as data recordation or data storage may be passed on to one or more client computers. A client computer can have its own processor, input means, and memory, or it may be a dumb terminal which does not have its own independent processing capabilities, but relies on the computational resources of another computer, such as a server, to which it is connected or networked.

The computer system of the invention may be networked with other computers over a local area network (LAN) connection or via an Internet connection or be cloud-based. The system may also comprise a backup system which retains a copy of the data generated or processed by the system.

The computer system may run on any particular architecture or operating systems (OS) such as UNIX/Linux; SPARC, POWER, Pentium, Celeron, Core, and Itanium-based systems; z/Architecture; and Apple OSX and Microsoft Windows. Similarly, the computer programming instructions can be written using any suitable computer language such as but not limited to Python, Ruby, Java, Javascript, and C/C++, and combination approaches can be used, such as Python for underlying programming and Javascript/HTML for user interfaces via a remote device.

In certain embodiments, the system has the capability of being managed remotely, for example, for updates to the computer programming instructions. The system can also generate alerts via network messages, E-mail, API alerts, or other techniques to notify an administrator of status changes or for troubleshooting.

Another aspect of the invention relates to a computer program product comprising a non-transitory computer-readable medium containing a program wherein the program, when executed by a computer, causes the computer to execute a method of generating a pre-vote outcome, the method comprising: receiving, by the computer, pre-votes from a plurality of shareholders for a proposition; adjusting each shareholder's pre-vote by a reliability factor to obtain an adjusted pre-vote for each shareholder, wherein the reliability factor comprises a correlation of a shareholder's pre-vote relative to the shareholder's historical vote; anonymizing the pre-votes; generating the pre-vote outcome for the proposition based on the adjusted and anonymized pre-votes; and displaying, by the computer in electronic form, information about the pre-vote outcome.

Examples of computer-program products are computer-readable storage media and computer-readable data carriers such as USB drives, CD/DVD disks, and hard drives. Such systems can also be used for data backup or archival.

Another aspect of the present invention is directed to a system for providing access to a pre-vote outcome of a proposition. The inventive system comprises an electronic database and a server for receiving and processing a request for access to the database from a remote device. The electronic database has a configuration for entry and retrieval of data and comprises information such as: bibliographic voter data for a plurality of shareholders; a value corresponding to a generated pre-vote outcome for the plurality of shareholders; and a classification of each shareholder's pre-vote for a proposition, adjusted pre-vote, and reliability factor, wherein the reliability factor comprises a correlation of a particular shareholder's pre-vote in relation to the shareholder's historical vote, and wherein the adjusted pre-votes are anonymized prior to generation of the pre-vote outcome.

The inventive system can be optionally configured to provide a subscriber with access to the database via a remote device upon payment of a fee. This access can be provided via a login or other authentication procedure to restrict access to authorized users. The server of the system may be a local computer or cloud-based, and operatively connected to a remote device over the Internet.

In addition to the server and electronic database, the system may also comprise a pre-vote generation application configured to receive a shareholder's pre-vote and populate the database with the received pre-vote. The pre-vote generation application may run on or be directed by the server or another component of the system. The system can be configured to update the value in the database corresponding to the generated pre-vote outcome upon receipt of the shareholder's pre-vote. The pre-vote generation application may be configured to detect a change in the data of the database, for example, using query notification or change tracking, and thereby generate an updated pre-vote outcome.

The invention provides a shareholder's pre-vote relative to its subsequent actual vote for each proposition. In order to maintain the integrity of the pre-vote outcome of the invention, shareholders may be required to certify that they are voting their pre-votes in the same manner as they will in the subsequent corporate vote. Discrepancies between pre-votes and actual votes are addressed by each shareholder's reliability factor. The number of pre-votes to which a shareholder is entitled will generally correspond to the number of votes that the shareholder is entitled to cast at the corporate vote. For example, if a shareholder owns 1,000 shares of XYZ Inc. and can cast 1,000 regular votes during the corporate vote, the shareholder can cast 1,000 pre-votes as part of the present system prior to regular voting. Shareholders wishing to abstain from voting in a particular pre-vote may do so and the present invention will adjust the pre-vote outcome to reflect abstentions for all or part of a pre-vote.

Certain shareholders may have special voting privileges during a corporate vote as a result of participating in multiple classes of shareholders. For example, one class of shareholders may have one vote per share, while another class of shareholders may have ten votes per share. The number of pre-votes which can be cast by shareholders will reflect such voting entitlements.

In another embodiment, the pre-votes may serve as proxies of actual votes and shareholders will not need to vote in the subsequent corporate vote. In other words, the pre-votes received in accordance with the invention will be counted as actual votes. Such an arrangement may require prior coordination with the issuer and shall be conducted in accordance with industry regulations and practices.

The present invention may also take into account split pre-votes. For example, if a shareholder has 100 eligible pre-votes, the shareholder may vote the pre-votes for one outcome of the proposition, or the shareholder may split the pre-votes among a number of outcomes of the proposition. Using the example of an election of a board member, a shareholder may vote a given number or percentage of pre-votes for one outcome and vote the remaining pre-votes or percentage for another outcome, such as 80% of the pre-votes against a proposition and the remaining 20% of the pre-votes abstaining.

Pre-votes cast by shareholders for a corporate vote may be cast for a single proposition or for multiple propositions. The pre-votes for each proposition will be segregated to prevent commingling and inaccurate generation of the pre-vote outcome.

The invention will now be described with reference to the Figures, wherein like reference numerals refer to like elements.

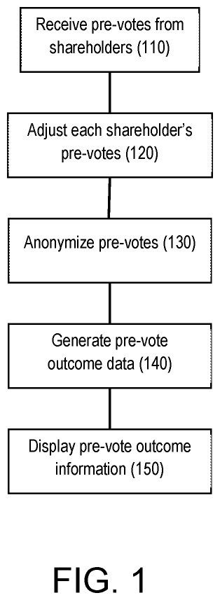

FIG. 1 is a flow chart illustrating steps for generating a pre-vote outcome for a corporate vote. The method comprises receiving, by a computer, pre-votes from a plurality of shareholders (110) for a proposition to be voted on during the corporate vote. Each shareholder's pre-vote is adjusted (120) by a reliability factor to obtain an adjusted pre-vote for each shareholder. The reliability factor comprises a correlation of a particular current shareholder's pre-vote relative to the shareholder's historical vote or voting history. The adjusted pre-votes are anonymized (130) to protect each shareholder's privacy. The system then generates the pre-vote outcome for the proposition (140) based on the adjusted and anonymized pre-votes. Information about the pre-vote outcome can then be made available (150) in electronic form to interested parties. Having the generated pre-vote outcome data, the data may be further refined for particular classes of shareholders such as active shareholders.

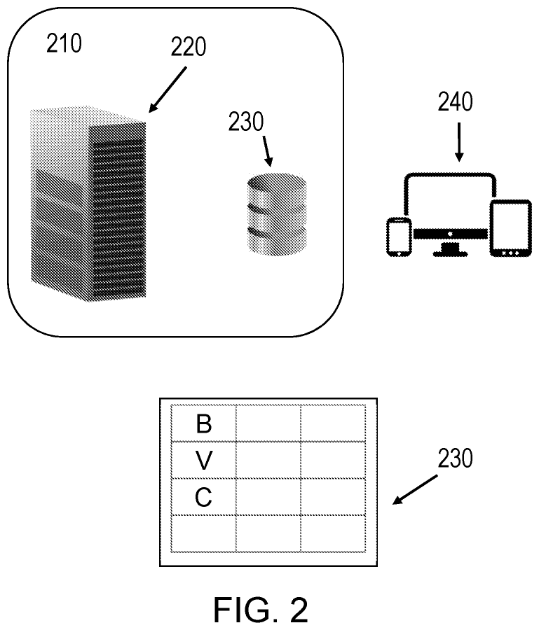

FIG. 2 shows an embodiment of a system for generating a pre-vote outcome for a corporate vote. The system 210 comprises an electronic database 230 and a server 220 for receiving and processing access to the database 230. A remote device 240 is shown for requesting access to the database 230. The remote device 240 can be any device which has access to the database 230.

The database 230 stores information for use by the system to generate the pre-vote outcome, such as bibliographic voter data (represented by the letter B) for a plurality of shareholders; a value corresponding to a generated pre-vote outcome for the plurality of shareholders (represented by the letter V); and a classification of each shareholder's pre-vote (represented by the letter C) for a proposition, adjusted pre-vote, and reliability factor, wherein the reliability factor comprises at least a correlation of a particular shareholder's pre-vote in relation to the shareholder's historical vote, and wherein the adjusted pre-votes are anonymized prior to generation of the pre-vote outcome. Interested parties are assigned a login to access the database 230 via the remote device 240. Upon receipt of a valid request for access from an authorized login via the remote device 240, the server 220 looks up the requested information including the pre-vote outcome V in the database 230 and transmits this information electronically to the remote device 240.

A remote device 240 may be used to request access to the server, and the remote device can be any kind of electronic device electronically connected to the server such as a personal computer or a portable computer such as a laptop, tablet, or mobile telephone. The server and remote device may be connected over an electronic network, such as the internet, a LAN or WAN connection, VPN, or telephone network either through a wired or wireless connection, and may have a dashboard interface for data input and display. A remote device may also be used to connect to and operate the server if it does not have its own data input and display devices such as a keyboard and monitor, or to provide additional ways of connecting to the server.

The present invention will now be described with reference to the Examples below.

### Example 1

In Example 1, three shareholders A, B, and C are voting their pre-votes for a proposition. All three shareholders are active shareholders. Passive shareholders have been excluded from participating in the pre-vote in this example. Shareholders A and B have voted YES for the proposition while shareholder C has voted NO. Shareholders A, B, and C each have 100 shares and therefore each shareholder has 100 pre-votes. Shareholders A and B have a reliability factor of 100% while shareholder C has a reliability factor of 50%. Shareholders A and B each have 100 adjusted pre-votes (100 shares×100% reliability factor). Shareholder C has 50 adjusted pre-votes (100 shares×50% reliability) indicating that shareholder C has a 50% chance of voting YES in the corporate vote even though the pre-vote is NO. The total number of pre-votes is 300 and the total number of adjusted pre-votes is 250. The percent of pre-votes voting YES for the proposition is therefore 250/300 or 80%. The entry of “Yes” in the “Pass” field indicates that the pre-vote outcome is that 80% of the pre-votes were voted in favor of the proposition.

| | | | | | | Adjusted | |
|---|---|---|---|---|---|---|---|
| | | | Reli- | | | Pre-Votes | |
| | | | ability | | | For | |
| Share- | Shrhldr | | Factor | | Pre- | Passing | |
| holder | Status | Vote | (%) | Shares | Votes | Proposition | Pass? |
| A | Active | YES | 100 | 100 | 100 | 100 | |
| B | Active | YES | 100 | 100 | 100 | 100 | |
| C | Active | NO | 50 | 100 | 100 | 50 | |
| Total | | | | | 300 | 250 | $\frac{250}{300} = 80 \%$ |
| | | | | | | | Yes |

The results of the pre-vote, i.e., that 80% of the pre-votes of active shareholders are in favor of the proposition, is provided to subscribers such as passive shareholders and other interested parties. The pre-vote shows that by a wide margin, participating shareholders approve of the proposition. Therefore other shareholders, such as indexers and passive shareholders, may be guided to vote in the same manner during the subsequent corporate vote.

### Example 2

Example 2 shows a different voting pattern as compared to Example 1. In this example of the present invention, the system calculates the chance of a proposition passing in view of the shareholders voting NO. Shareholder A provides a pre-vote of NO and has a reliability factor of 100%. Given this reliability factor, there is very low to nil expectation that this shareholder will vote differently than from its pre-vote and thus the adjusted pre-vote value for this shareholder in favor of passing the proposition is very low. Shareholder B provides a pre-vote of NO and has a reliability factor of 70%, indicating that there is a 30% chance that the shareholder's actual vote will be the opposite than its pre-vote. Shareholder B's adjusted pre-votes in favor of passing the proposition is therefore 30 (100 shares×(100−70)% reliability). Shareholder C provides a pre-vote of YES and has an 80% reliability factor, giving an adjusted pre-vote value for passing the proposition of 80. Consequently, while the total number of pre-votes is 300, the total number of adjusted pre-votes in favor of passing the proposition is 110. The percent of pre-votes in favor of the proposition is therefore 110/300 or 36%. The entry of “No” in the “Pass” column indicates that the pre-vote outcome is “No” because only 36% of the pre-votes tallied in favor of the proposition which is less than a majority.

| | | | | | | Adjusted | |
|---|---|---|---|---|---|---|---|
| | | | Reli- | | | Pre-Votes | |
| | | | ability | | | For | |
| Share- | Shrhldr | | Factor | | Pre- | Passing | |
| holder | Status | Vote | (%) | Shares | Votes | Proposition | Pass? |
| A | Active | NO | 100 | 100 | 100 | 0 | |
| B | Active | NO | 70 | 100 | 100 | 30 | |
| C | Active | YES | 80 | 100 | 100 | 80 | |
| Total | | | | | 300 | 110 | $\frac{110}{300} = 36 \%$ |
| | | | | | | | No |

The results of the pre-vote, that is, that 36% of the pre-votes were in favor of the proposition, is provided to subscribers such as indexers and/or passive shareholders. This information is then used by the indexers or passive shareholders in determining how to vote during the subsequent corporate vote.

### Example 3

Example 3 shows a more complex pre-voting pattern as compared to the prior two Examples. In Example 3, shareholders A, B, and C are active shareholders while shareholder D is a passive shareholder. For this example, only pre-votes from active shareholders will be considered and pre-votes from passive shareholders will be removed from consideration. Consequently, even though all four shareholders entered pre-votes, only the pre-votes from shareholder A, B, and C will be used for generating the pre-vote outcome data, and the pre-votes for shareholder D will be disregarded but not deleted.

Shareholders A and B voted YES for the subject proposition and have a reliability factor of 100% while shareholder C voted NO and has a reliability factor of 80%. Shareholders A and B have adjusted pre-votes of 100 (100 pre-votes×100% reliability) while shareholder C has an adjusted pre-vote of 20 (100 pre-votes×(100−80)% reliability). The total number of adjusted pre-votes is 220 while the total number of pre-votes is 300, thereby giving a percent of pre-votes in favor of the proposition of 73%. The entry of “Yes” in the “Pass” column indicates that the pre-vote outcome is “Yes” as the majority (73%) of shareholder pre-votes were in favor of the proposition.

| | | | | | | Adjusted | |
|---|---|---|---|---|---|---|---|
| | | | Reli- | | | Pre-Votes | |
| | | | ability | | | For | |
| Share- | Shrhldr | | Factor | | Pre- | Passing | |
| holder | Status | Vote | (%) | Shares | Votes | Proposition | Pass? |
| A | Active | YES | 100 | 100 | 100 | 100 | |
| B | Active | YES | 100 | 100 | 100 | 100 | |
| C | Active | NO | 80 | 100 | 100 | 20 | |
| D | Passive | NO | 50 | 100 | — | — | |
| Total | | | | | 300 | 220 | $\frac{220}{300} = 73 \%$ |
| | | | | | | | Yes |

The pre-vote outcome, that 73% of active shareholders were in favor of the proposition, is provided to subscribers. Indexers and/or passive shareholders viewing the results are informed that a majority of active shareholder votes are in favor of the proposition. In this example, shareholders C and D are seen to have pre-voted NO, contrary to the other shareholders.

### Example 4

Example 4 shows the same voting pattern as in Example 3 in which shareholders A, B, and C are active shareholders while shareholder D is a passive shareholder. However, for this example, pre-votes from all shareholders will be considered for determination of the pre-vote outcome.

Shareholders A and B voted YES for the subject proposition and have a reliability factor of 100% while shareholder C voted NO and has a reliability factor of 80%. Shareholders A and B have adjusted pre-votes of 100 (100 pre-votes×100% reliability) while shareholder C has an adjusted pre-vote of 20 (100 pre-votes×(100−80)% reliability). Shareholder D has an adjusted pre-vote of 50 (100 pre-votes×(100−50)% reliability). The total number of adjusted pre-votes is 270 while the total number of pre-votes is 400, thereby giving a percent of pre-votes in favor of the proposition of 68%. The entry of “Yes” in the “Pass” column indicates that the pre-vote outcome is “Yes” as the majority (68%) of shareholder pre-votes were in favor of the proposition. In certain embodiments of the invention, there may also be a parameter to handicap or discount a passive shareholder's pre-vote to reflect a lesser value as compared to active shareholders.

| | | | | | | Adjusted | |
|---|---|---|---|---|---|---|---|
| | | | Reli- | | | Pre-Votes | |
| | | | ability | | | For | |
| Share- | Shrhldr | | Factor | | Pre- | Passing | |
| holder | Status | Vote | (%) | Shares | Votes | Proposition | Pass? |
| A | Active | YES | 100 | 100 | 100 | 100 | |
| B | Active | YES | 100 | 100 | 100 | 100 | |
| C | Active | NO | 80 | 100 | 100 | 20 | |
| D | Passive | NO | 50 | 100 | 100 | 50 | |
| Total | | | | | 400 | 270 | $\frac{270}{400} = 68 \%$ |
| | | | | | | | Yes |

The pre-vote outcome, that 68% of shareholders were in favor of the proposition, is provided to subscribers. Indexers and/or passive shareholders viewing the results are informed that a majority of shareholder pre-votes are in favor of the proposition. In this example, shareholders C and D are seen to have pre-voted NO, contrary to the other shareholders. If desired, anonymized voting data can be provided to interested parties such as subscribers in addition to the pre-vote outcome.

Examples of changes, substitutions, and alterations are ascertainable by one skilled in the art and could be made without departing from the scope of the invention disclosed herein. All references cited herein are incorporated by reference in their entirety and made part of this application.

The various embodiments described above can be combined to provide further embodiments. Aspects of the embodiments can be modified to provide yet further embodiments. The disclosed features may be implemented, in any combination and subcombination (including multiple dependent combinations and subcombinations), with one or more other features described herein. The various features described or illustrated above, including any components thereof, may be combined or integrated in other systems. Moreover, certain features may be omitted or not implemented.

Other objects, advantages and embodiments of the various aspects of the present invention will be apparent to those who are skilled in the field of the invention and are within the scope of the description and the accompanying figures. For example, but without limitation, structural or functional elements might be rearranged, or method steps reordered, consistent with the present invention. Similarly, an element may comprise a single instance of an element or comprise a plurality of elements, such plurality functioning as a single unitary component. The structure of the invention described in various embodiments is not meant to limit the invention to those embodiments or aspects of the present invention, and other components that may accomplish similar tasks may be implemented as well. Similarly, principles according to the present invention, and methods and systems that embody them, could be applied to other examples, which, even if not specifically described here in detail, would nevertheless be within the scope of the present invention.

What is claimed is:

1. A computer-implemented method for generating a pre-vote outcome of a proposition, the method comprising:
receiving, by the computer, pre-votes from a plurality of shareholders for the proposition;
adjusting each shareholder's pre-vote by a reliability factor to obtain an adjusted pre-vote for each shareholder, wherein the reliability factor comprises a correlation of a shareholder's pre-vote relative to the shareholder's historical vote;
anonymizing the pre-votes;
generating the pre-vote outcome for the proposition based on the adjusted and anonymized pre-votes; and
making available, by the computer in electronic form, information about the pre-vote outcome.

2. The method according to claim 1, wherein the shareholders are holders of an equity security.

3. The method according to claim 1, wherein the proposition is selected from the group consisting of a periodically recurring corporate vote and a specially-scheduled vote.

4. The method according to claim 1, further comprising providing the pre-vote outcome to a subscriber upon payment of a fee.

5. The method according to claim 1, further comprising providing the pre-vote outcome to a subscriber upon payment of a fee prior to dissemination to non-subscribers.

6. The method according to claim 1, wherein one or more of the shareholders is a beneficial owner of a subject security.

7. The method according to claim 1, wherein one or more of the shareholders is selected from the group consisting of a trustee, custodian, agent, and proxy.

8. The method according to claim 1, further comprising generating separate pre-vote outcomes for active shareholders and passive shareholders.

9. The method according to claim 1, further comprising providing an outcome probability for likelihood of passage of the proposition based on the pre-votes and shareholder reliability factor information.

10. The method according to claim 9, wherein the outcome probability is generated for a category of shareholders selected from the group consisting of (a) all shareholders; (b) each individual shareholder; and (c) a predefined class of shareholders.

11. The method according to claim 10, wherein the predefined class consists of active shareholders.

12. The method according to claim 1, further comprising generating voting analytics for each shareholder based on the shareholder's pre-vote and supplemental pre-voting data.

13. The method according to claim 1, further comprising requiring receipt of pre-votes from a minimum number of shareholders of an issuer in order to generate the pre-vote outcome.

14. The method according to claim 1, further comprising requiring receipt of pre-votes from a minimum percentage of shareholders of the issuer in order to generate the pre-vote outcome.

15. The method according to claim 1, further comprising providing an alternative vote summary if the number of voting shareholders is below a threshold.

16. The method according to claim 1, further comprising providing an alternative vote summary if the percentage of voting shareholders is below a threshold.

17. The method according to claim 1, further comprising predicting a shareholder's pre-vote based on the shareholder's voting history, and using the predicted pre-vote to generate the pre-vote outcome.

18. The method according to claim 1, further comprising adjusting a shareholder's reliability factor based on one or more characteristics selected from the group consisting of the number of securities owned, type of securities owned, historical voting, shareholder diversification, and shareholder leverage.

19. The method according to claim 1, further comprising adjusting a shareholder's probability of voting based on the shareholder's reliability score.

20. The method according to claim 1, further comprising:
predicting a shareholder's pre-vote based upon the shareholder's voting history; and
generating the pre-vote outcome using the shareholder's predicted pre-vote.

21. The method according to claim 20, further comprising:
upon receipt of the shareholder's pre-vote, replacing the predicted pre-vote with the received pre-vote and generating an updated pre-vote outcome with the shareholder's received pre-vote.

22. The method according to claim 1, further comprising excluding pre-votes from a class of shareholders from the pre-vote outcome.

23. The method according to claim 22, wherein the class of shareholders consists of passive shareholders.

24. The method according to claim 1, further comprising restricting pre-voting to a class of shareholders.

25. The method according to claim 24, wherein the class of shareholders consist of active shareholders.

26. The method according to claim 1, further comprising defining an eligibility threshold in order for a shareholder to cast a pre-vote.

27. The method according to claim 26, wherein the eligibility threshold is selected from the group consisting of owning a minimum number of outstanding securities of an issuer, a minimum percentage of outstanding securities of a company, and a portfolio of outstanding securities of an issuer having a minimum asset value.

28. The method according to claim 26, wherein the eligibility threshold is selected from the group consisting of managing a minimum number of outstanding securities of an issuer, a minimum percentage of outstanding securities of a company, and a portfolio of outstanding securities of an issuer having a minimum asset value.

29. The method according to claim 1, wherein the proposition is selected from the group consisting of an election of a director, election of a officer, a corporate resolution, and a shareholder resolution.

30. The method according to claim 1, wherein the corporate vote comprises a plurality of propositions, and the method further comprises generating a respective pre-vote outcome for each of the plurality of propositions.

31. A system for generating a pre-vote outcome of a proposition, the system comprising:
a database configured to store bibliographic voter information and pre-votes for a plurality of shareholders, and a value corresponding to the generated pre-vote outcome;
a remote device connected to a server over an electronic network and configured for requesting access to the database;
the server comprising a memory, a processor, and computer program instructions which, when executed by a computer, cause the server to execute a method of generating a pre-vote outcome,
the method comprising:
receiving, by the computer, pre-votes from a plurality of shareholders for the proposition;
adjusting each shareholder's pre-vote by a reliability factor to obtain an adjusted pre-vote for each shareholder, wherein the reliability factor comprises a correlation of a shareholder's pre-vote relative to the shareholder's historical vote;
anonymizing the pre-votes;
generating the pre-vote outcome for the proposition based on the adjusted and anonymized pre-votes; and
displaying, by the computer in electronic form, information about the pre-vote outcome.

32. The system according to claim 31, wherein the remote device is selected from the group consisting of a personal computer, a portable computer, a tablet, and a mobile telephone.

33. The system according to claim 31, wherein the remote device is configured to provide a dashboard interface for data input and display.

34. A computer program product comprising a non-transitory computer-readable medium containing a program, wherein the program, when executed by a computer, causes the computer to execute a method of generating a pre-vote outcome, the method comprising:
receiving, by the computer, pre-votes from a plurality of shareholders for a proposition;
adjusting each shareholder's pre-vote by a reliability factor to obtain an adjusted pre-vote for each shareholder, wherein the reliability factor comprises a correlation of a shareholder's pre-vote relative to the shareholder's historical vote;
anonymizing the pre-votes;
generating the pre-vote outcome for the proposition based on the adjusted and anonymized pre-votes; and
displaying, by the computer in electronic form, information about the pre-vote outcome.

35. A system for providing access to a pre-vote outcome for a corporate vote, the system comprising:
an electronic database comprising:
bibliographic voter data for a plurality of shareholders;
a value corresponding to a generated pre-vote outcome for one or more of the shareholders; and
a classification of each shareholder's pre-vote for a proposition, adjusted pre-vote, and reliability factor, wherein the reliability factor comprises a correlation of a shareholder's pre-vote relative to the shareholder's historical vote, and wherein the adjusted pre-votes are anonymized prior to generation of the pre-vote outcome; and
a server for receiving and processing a request for access to the database from a remote device.

36. The system according to claim 35, wherein the system is configured to provide a subscriber with access to the database via a remote device upon payment of a fee.

37. The system according to claim 35, wherein the system is configured to provide a subscriber with access to the value corresponding to the generated pre-vote outcome upon payment of a fee before providing access to a non-fee payer.

38. The system according to claim 35, further comprising a pre-vote generation application configured to receive a shareholder's pre-vote and populate the database with the received pre-vote, and wherein the system is configured to update the value corresponding to the generated pre-vote outcome upon receipt of the shareholder's pre-vote.

39. The system according to claim 35, wherein the server is cloud-based and operatively connected to a remote device over the Internet.

40. The system according to claim 35, wherein the remote device is selected from the group consisting of a personal computer, a portable computer, a tablet, and a mobile telephone.
